(19) United States
(12) Patent Application Publication
(10) Pub. No.: US 2004/0212191 A1
(43) Pub. Date: Oct. 28, 2004

(54) Fluid line connector assembly

(76) Inventors: Evan J. Segal, Pittsburgh, PA (US); Todd R. McCurdy, Irwin, PA (US); Doug W. Keeports, Murrysville, PA (US); Michael T. Lyon, Greensburg, PA (US); Timothy D. Struna, Pittsburgh, PA (US)

Correspondence Address: Christopher B. Fagan, Esq., Fay, Sharpe, Fagan, Minnich & McKee, LLP, Seventh Floor, 1100 Superior Avenue, Cleveland, OH, 44114-2518, US

(21) Appl. No.: 10/809,160

(22) Filed: Mar. 25, 2004

Related U.S. Application Data
(60) Provisional application No. 60/457,530, filed on Mar. 25, 2003.

(51) Int. Cl. F16L 31/00

(52) U.S. Cl. 285/334.5; 285/222.1; 285/903; 285/354

(57) ABSTRACT

A fluid line connector assembly includes a length of flexible tubing having a tubing end and a first fitting body received on the tubing end. A second is secured to the first fitting body, and at least one of the first fitting body and the second fitting body forms a fluid-tight connection with the tubing end. A third fitting body is rotatably supported on the second end fitting. A sealing member forms a fluid-tight seal between the second fitting body and the third fitting body. A method of assembling a fluid line connector assembly is also described.

This application claims priority from U.S. Provisional Patent Application No. 60/457,530 filed on March 25 2003, which is hereby incorporated herein by reference in its entirety.

### BACKGROUND OF THE INVENTION

This invention relates to the art of fluid line connector assemblies and, more particularly, to thin-walled, flexible fluid line connector assemblies for use in low-pressure applications.

Thin-walled, flexible fluid line connector assemblies have been provided heretofore and generally include a length of thin-walled, corrugated, flexible tubing having opposing non-corrugated tubing ends, a flare nut retained on each tubing end and a flare fitting cooperable with each flare nut to form a fluid-tight seal between the flare fitting, the tubing end and the flare nut. The tubing ends commonly include a generally cylindrical journal portion and a radially outwardly extending flare portion. The flare nuts are retained on the non-corrugated tubing ends by the flare portion, which is deformed radially outwardly after assembly with the flare nut to engage the same and thereby prevent removal thereof from the end of the length of tubing. To form the fluid-tight seal with the flexible tubing, a flare fitting is threadably engaged into each of the flare nuts. The flare fitting includes a frustoconical-leading surface that compressively engages the flare portion of the tubing end. As the flare fitting and flare nut are threadably tightened together, the frustoconical leading surface of the flare fitting displaces the flare portion of the flexible tubing against an interior surface of the flare nut. This displacement causes the flare portion of the tubing to be compressively engaged between the flare fitting and flare nut and causes a metal-to-metal seal to form between the tubing, the flare fitting and the flare nut such that the assembly becomes fluid tight.

A disadvantage of connector assemblies of the foregoing nature is that tightening the flare nut and flare fitting together to form the metal-to-metal seal with the flexible tubing causes the flare fitting, flare nut and flexible tubing to become rotatably fixed relative to one another. As such, the flare fitting and flare nut are not able to rotate relative to the thin-walled, flexible tubing. As a result, the connector assembly can be difficult to install, especially in areas having limited clearance and access. Additionally, the flexible tubing can become torsionally stressed during the installation of the connector assembly, which it is desirable to avoid where possible.

### BRIEF SUMMARY OF THE INVENTION

In accordance with the present invention, a fluid line connector assembly is provided that avoids or minimizes the problems and difficulties encountered in connection with connector assemblies of the foregoing nature while promoting an increase in performance and reliability, and maintaining a desired simplicity of structure, economy of manufacture and ease of installation.

More particularly in this respect, a fluid line connector assembly is provided and includes a length of flexible tubing having a tubing end. A first fitting body is received on the tubing end. A second fitting body is secured to the first fitting body. At least one of the first fitting body and the second fitting body forms a fluid-tight connection with the tubing end. A third fitting body is rotatably supported on the second fitting body. A sealing member forms a fluid-tight seal between the second fitting body and the third fitting body.

Another fluid line connector assembly is provided that includes a length of flexible tubing having a tubing end. A first fitting body is received on the tubing end. A second fitting body is rotatably supported on the first fitting body, and a sealing member forms a fluid-tight seal between the tubing end and one of the first fitting body and the second fitting body.

A further fluid line connector assembly is provided that includes a length of flexible tubing having a tubing end. A first fitting body is received on the tubing end. A second fitting body is secured to the first fitting body. At least one of the first fitting body and the second fitting body at least partially forms a compression seal along the tubing end. A third fitting body is rotatably supported on the second fitting body. A sealing member forms a fluid-tight seal between the second fitting body and the third fitting body.

Still another fluid line connector assembly is provided that includes a length of flexible tubing having a tubing end. A first fitting body is received on the tubing end. A second fitting body is secured to the first fitting body. A compression ring is captured on the tubing end between the first and second fitting bodies. The compression ring at least partially forms a compression seal along the tubing end. A third fitting body is rotatably supported on the second fitting body. A sealing member forms a fluid-tight seal between the second fitting body and the third fitting body.

A method of assembling a fluid line connector assembly is provided and includes the steps of: providing a length of flexible tubing having a tubing end, a first fitting body, a second fitting body having an inwardly extending groove, a third fitting body having an outwardly extending groove, a sealing member, and a retaining member; positioning the first fitting body on the tubing end; securing the second fitting body on the first fitting body and forming a fluid-tight seal between one of the first and second fitting bodies and the tubing end; positioning the sealing member on the second fitting body and the retaining member within at least a portion of the inwardly extending groove; positioning the third fitting body on the second fitting body such that the retaining member is received within at least a portion of the outwardly extending groove and the sealing member is compressively positioned between the second and third fitting bodies.

### BRIEF DESCRIPTION OF THE DRAWINGS

FIG. 1 is a cross-sectional view of a conventional connector assembly shown partly assembled.

FIG. 2 is a cross-sectional view of the conventional assembly of FIG. 1 shown fully assembled.

FIG. 3 is a partial cross-sectional view of a fluid line connector assembly in accordance with the present invention.

FIG. 4 is a partial cross-sectional view of one end of the fluid line connector assembly of FIG. 3.

FIG. 5 is a partial cross-sectional view of an alternate embodiment of a fluid line connector assembly in accordance with the present invention.

FIG. 6 is a partial cross-sectional view of one end of the fluid line connector assembly of FIG. 5.

FIG. 7 is a partial cross-sectional view of one end of another embodiment of a fluid line connector assembly in accordance with the present invention.

FIG. 8 is a partial cross-sectional view of one end of still another embodiment of a fluid line connector assembly in accordance with the present invention.

FIG. 9 is a partial cross-sectional view of one end of still another embodiment of a fluid line connector assembly in accordance with the present invention.

FIG. 10 is a partial cross-sectional view of one end of yet another embodiment of a fluid line connector assembly in accordance with the present invention.

FIG. 11 is a partial cross-sectional view of one end of a further embodiment of a fluid line connector assembly in accordance with the present invention.

FIG. 12 is a partial cross-sectional view of one end of still a further embodiment of a fluid line connector assembly in accordance with the present invention.

FIG. 13 is a partial cross-sectional view of one end of still a further embodiment of a fluid line connector assembly in accordance with the present invention.

FIG. 14 is a partial cross-sectional view of one end of yet a further embodiment of a fluid line connector assembly in accordance with the present invention.

FIG. 15 is a partial cross-sectional view of an end fitting assembly in accordance with the present invention.

FIG. 16 is a partial cross-sectional view of another embodiment of one end of a fluid line connector assembly in accordance with the present invention.

### DETAILED DESCRIPTION OF THE INVENTION

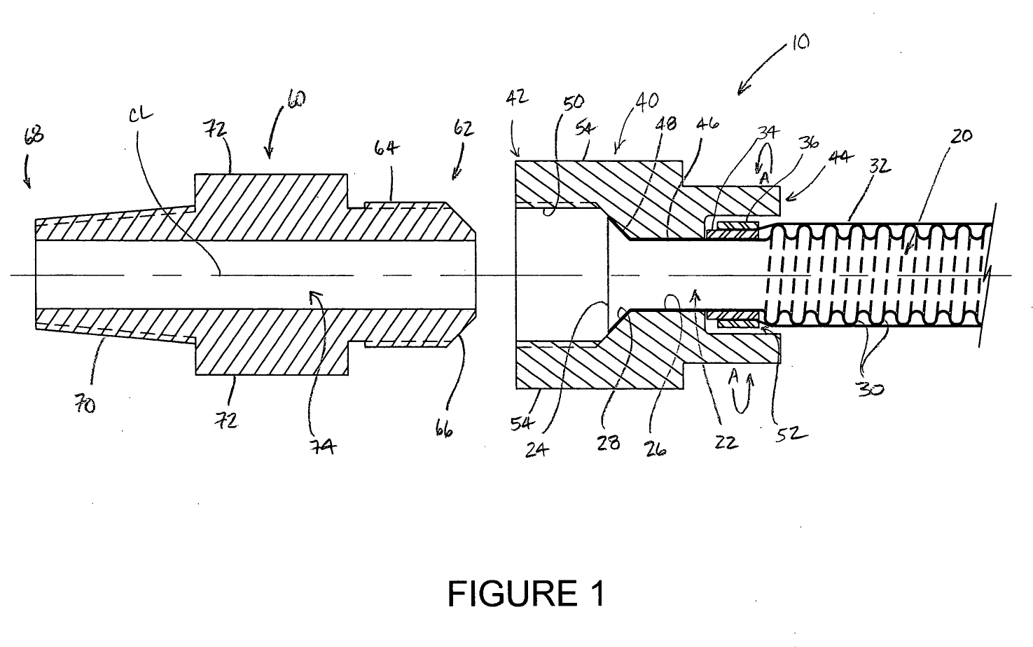

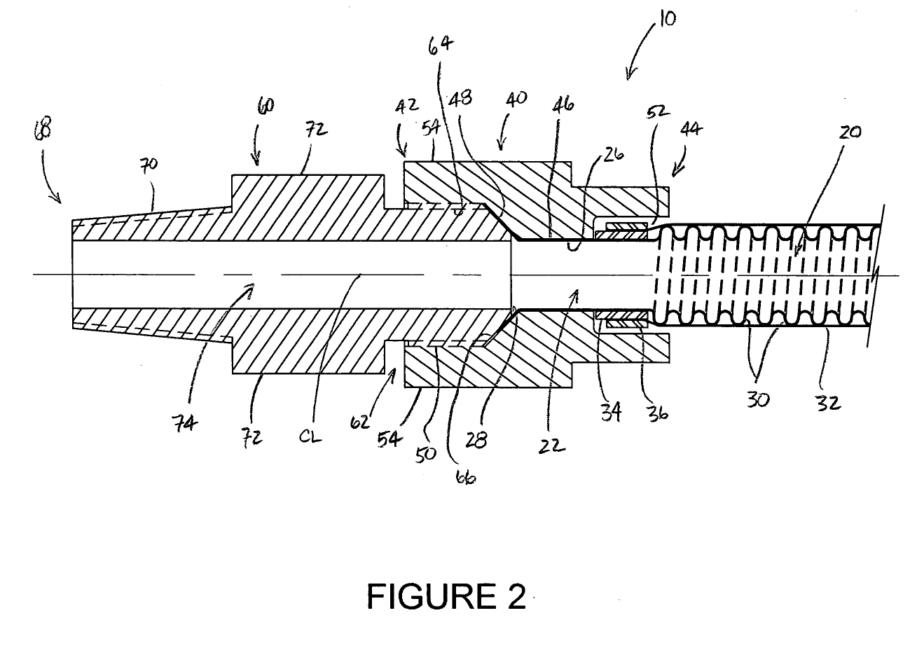

It will be appreciated that FIGS. 1 and 2 respectively illustrate a conventional fluid line connector assembly for connection between a transmission line and an appliance, such as a gas supply line and a gas stove. Such fluid line connector assemblies are generally known to those skilled in the art, and the following discussion of FIGS. 1 and 2 is merely provided to establish background, environment and terminology for further discussion of the preferred embodiments of the present invention.

FIG. 1 illustrates a conventional fluid line assembly 10 that includes a length of thin-walled, flexible tubing 20, a flare nut 40 and a flare fitting 60. The length of tubing 20 has two opposing ends 22, only one of which is shown in FIGS. 1 and 2. The tubing end 22 terminates at a tubing edge 24 and includes a journal portion 26 and a flare portion 28. The length of thin-walled, flexible tubing 20 has a plurality of helically extending tubing corrugations 30 and is formed from metal, typically stainless steel.

The flare nut 40 is retained on tubing 20 at tubing end 22 by flare portion 28. The flare nut has a threaded end 42 and a strain-relief end 44. A journal passage 46 extends through flare nut 40 and is cooperable with journal portion 26 of tubing end 22 such that the flare nut is freely rotatable about a central access CL of assembly 10 as shown by arrows A. Extending toward threaded end 42 from journal passage 46 is flare seating surface 48, which extends radially outwardly from the journal passage in a frustoconical manner. Female fitting threads 50 extend inwardly from threaded end 42 toward flare seating surface 48. The female fitting threads are generally coaxial with the journal passage 46. Opposite female fitting threads 50 at strain-relief end 44 is an axially-extending annular recess 52 that extends from the strain-relief end toward the threaded end and is adapted to receive at least a portion of one or more corrugations 30. Assembly 10 also includes a braided sheath 32 that extends axially along the length of the flexible tubing between the tubing ends. Sheath 32 is commonly formed from metallic wire. An inner collar 34 is received on journal portion 26 of tubing end 22, and at least a portion of the braided sheath extends along the exterior of the inner collar. A braid retaining collar 36 is crimped or otherwise deformed against the inner collar to retain the braided sheath therebetween. Wrench flats 54 are provided along at least a portion of the exterior of flare nut 40. Additionally, flare portion 28 of tubing end 22 extends radially outwardly from journal portion 26 adjacent flare seating surface 48 of flare nut 40. As indicated by arrow A, in the disassembled condition, flexible tubing 20 and flare nut 40 are rotatable relative to one another.

Flare fitting 60 is shown in FIG. 1 disassembled from tubing 20 and flare nut 40. The flare fitting has a fitting end 62 and a connection end 68. The fitting end has male fitting threads 64 adjacent a frustoconical, flare-engaging surface 66. The connection end includes connection threads 70. Positioned between the fitting end and the connection end of flare fitting 60 are wrench flats 72. A fluid passage 74 extends centrally through the flare fitting.

FIG. 2 shows male fitting thread 64 of flare fitting 60 engaged with female fitting threads 50 of flare nut 40. As flare fitting 60 is threadably rotated into flare nut 40, flare-engaging surface 66 of the flare fitting advances toward flare portion 28 of flexible tubing 20. Ultimately, flare-engaging surface 66 contacts flare portion 28, which is thereby forced against flare seating surface 48 of flare nut 40 effecting metal-to-metal contact between the three components. Once such contact has been made, further rotation of the flare fitting into the flare nut causes a metal-to-metal seal to form between flare-engaging surface 66, flare portion 28 of the flexible tubing, and flare seating surface 48 of the flare nut. This metal-to-metal seal is suitable for forming a fluid-tight passage through connector assembly 10. It will be appreciated, however, that this same metal-to-metal contact between the three components prevents rotation of these components relative to one another. As such, it will be appreciated that the entire connector assembly 10 must be rotated to threadably engage connector threads 70 into a fluid transmission line or appliance (not shown), for example.

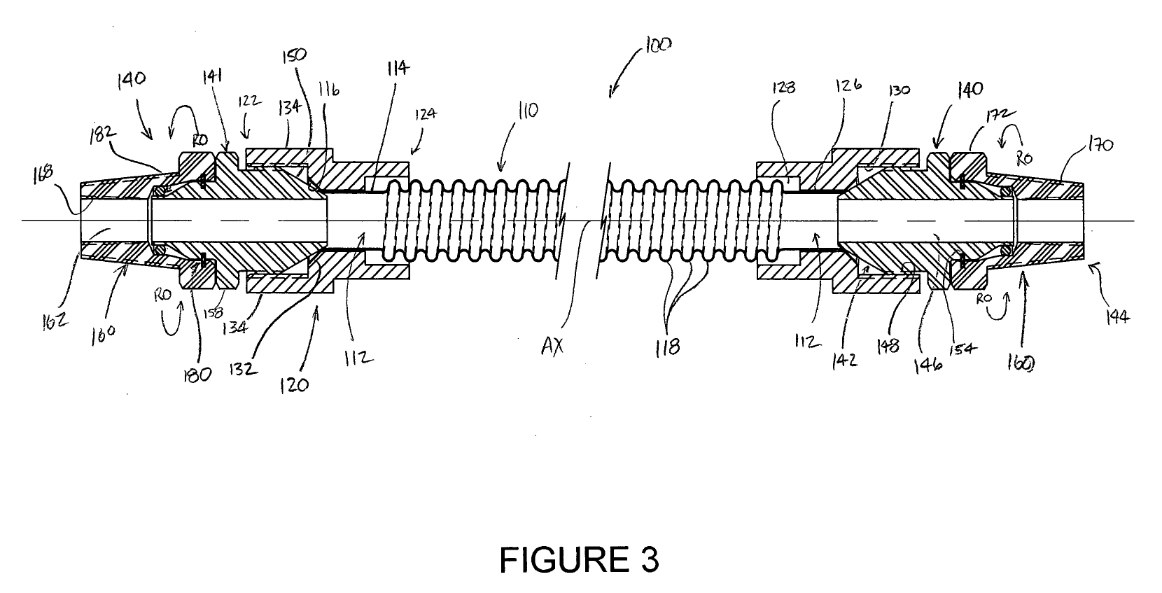

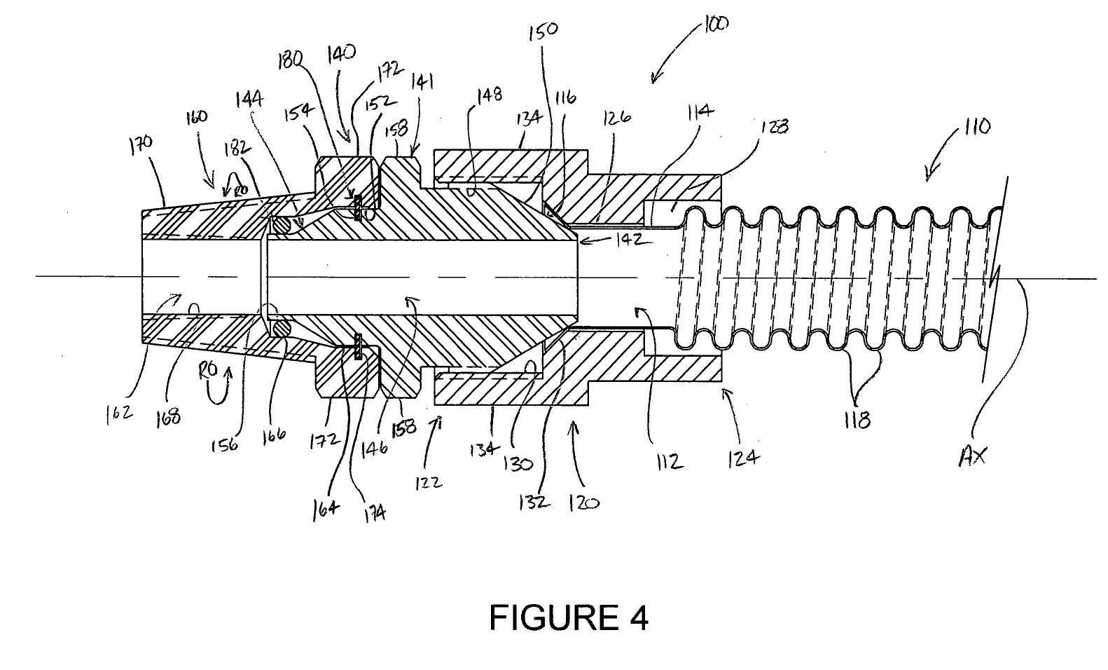

Referring in greater detail to FIGS. 3-6, wherein the showings are for the purposes of illustrating preferred embodiments of the invention only, and not for the purpose of limiting the invention. FIGS. 3 and 4 illustrate a fluid line connector assembly 100 that includes a length of thin-walled flexible tubing 110 with opposing ends 112, a flare nut 120, and a swivel fitting assembly 140 retained on each of the tubing ends. Tubing ends 112 are non-corrugated and generally cylindrical and include a journal portion 114 and a flare portion 116. Tubing corrugations 118 extend helically along the length of flexible tubing between tubing ends 112. Additionally, the length of flexible tubing defines a central axis AX.

As can be better seen in FIG. 4, flare nut 120 includes a threaded end 122 and a strain-relief end 124 opposite the threaded end. Extending generally centrally through the flare nut is a journal passage 126 which is cooperable with journal portion 114 of the tubing end 112 such that the flare nut is received on the tubing end and can rotate relative thereto. An annular recess 128 extends into the flare nut from strain-relief end 124. Flare nut 120 is oriented on the tubing end such that annular recess 128 receives at least a portion of one or more helical corrugations 118. A plurality of female threads 130 extend inwardly from threaded end 122 opposite strain-relief end 124. A flare seating surface 132 extends radially outwardly in a frustoconical manner from journal passage 126 toward female threads 130. The flare seating surface is adapted to cooperate with flare portion 116 of tubing end 112. Wrench flats 134 are disposed along the exterior of flare nut 120 between the threaded and strain-relief ends.

Swivel fitting assembly 140 includes a base fitting 141 that has a tube-engaging end 142 and a connection end 144. A passage 146 extends generally centrally through the base fitting between the opposing ends thereof. The tube-engaging end includes a plurality of male threads 148 that threadably engage female threads 130 of flare nut 120. A flare-engaging surface 150 extends from the tube-engaging end toward the male threads. Opposite the tube-engaging end at connection end 144, a generally cylindrical shoulder portion 152 is provided inwardly of the connection end. A retaining ring groove 154 extends radially inwardly along shoulder portion 152. A sealing portion 156 is provided axially outwardly of shoulder portion 152. A plurality of wrench flats 158 extend along the outside of base fitting 141 for the tightening thereof into flare nut 120.

Threaded end cap 160 has a passage 162 extending therethrough. The passage includes a bearing surface 164, a sealing surface 166 and a plurality of female threads 168. A plurality of male threads 170 extend along the exterior of the threaded end cap, and wrench flats 172 are provided for torsionally rotating the threaded end cap to connect to a fluid transmission line or appliance. Bearing surface 164 is cooperable with shoulder portion 152 of the base fitting such that the threaded end cap will rotate relative thereto, as indicated by arrows RO. A retaining ring groove 174 extends radially outwardly from bearing surface 164. Threaded end cap 160 is supported on base fitting 140 such that retaining ring grooves 154 and 174 are axially aligned radially opposite one another for each to receive at least a portion of a retaining ring 180, that axially retains the threaded end cap on the base fitting while allowing the threaded end cap to remain freely rotatable relative thereto, again as indicated by arrows RO. A sealing member, such as o-ring 182, for example, is compressively positioned between the sealing portion of the base fitting and the sealing surface of the threaded end cap to form a fluid-tight seal therebetween.

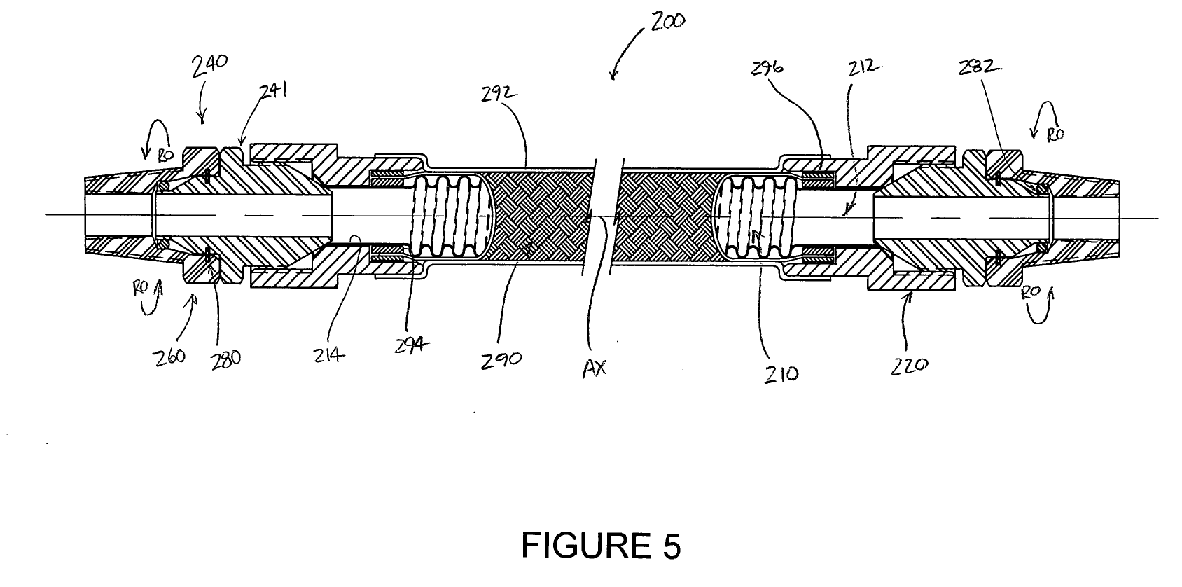

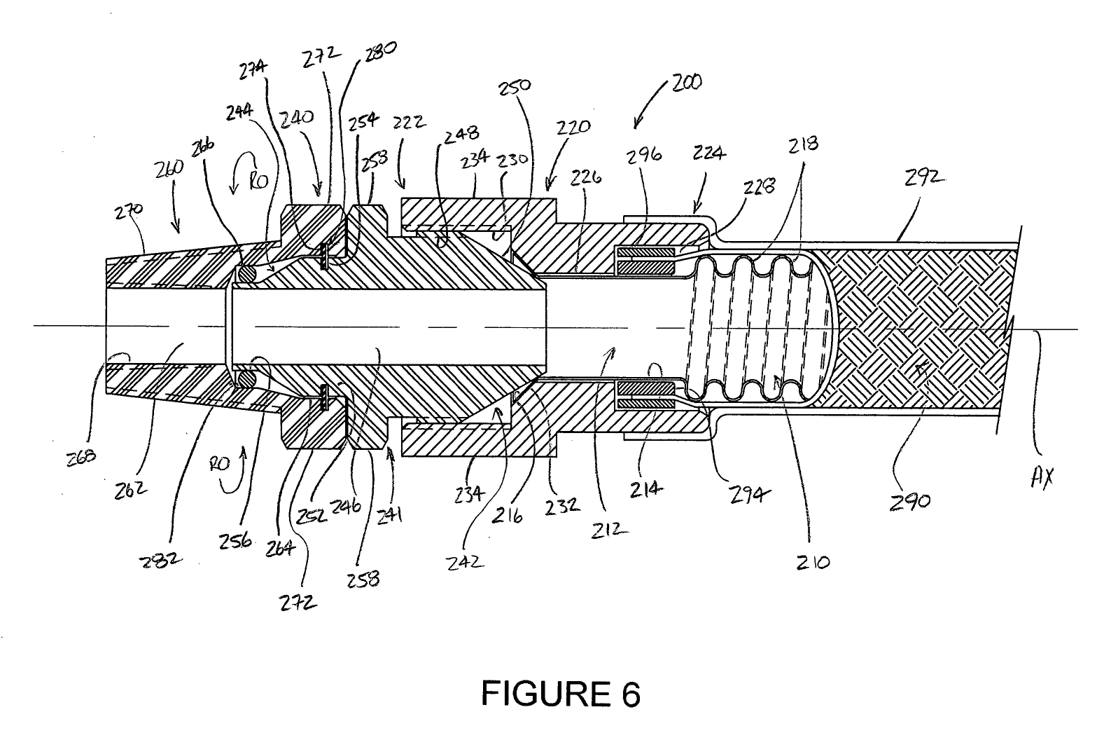

FIGS. 5 and 6 illustrate a fluid line connector assembly 200 that is substantially identical to connector assembly 100 discussed hereinbefore. However, connector assembly 200 further includes a braided sheath 290 and a coating layer 292 disposed along the exterior of the tubing. An inner collar 294 is supported on journal portion 214 axially inwardly of flare nut 220. At least a portion of braided sheath 290 extends along the exterior of each inner collar 294 and a braid retaining collar 296 is positioned radially outwardly of each inner collar and crimped or otherwise deflected radially inwardly to secure the end of the braided sheath therebetween. Additionally, coating layer 292 may be provided along the exterior of the braided sheath and portions of the flare nut to provide improved cleanability and other benefits as may be desired in certain applications. The coating layer is formed from a flexible plastic material, preferably plasticized polyvinylchloride. However, a variety of other suitable flexible materials can be used, such as polyethylene or synthetic rubber, for example. It should be appreciated, however, that the coating layer is optional in the embodiment illustrated in FIGS. 5 and 6.

In assembling a fluid line connector assembly 100 in accordance with the present invention, a length of flexible tubing 110 that has a pair of opposing tubing ends 112 that are generally cylindrical and non-corrugated, as discussed above, is first provided. Next, one or more flare nuts 120 are provided and installed on at least one of the tubing ends. Each tubing end that has received a flare nut is then flared radially outwardly, which prevents the axial removal of the flare nut from each end. Thereafter, a swivel fitting assembly 140 is provided that includes a base fitting 141, a threaded end cap 160, a retaining ring 180 and one or more sealing members 182. Preferably, the swivel fitting assembly will be pre-assembled, and the base fitting will then be threaded into the flare nut to form a metal-to-metal seal between the base fitting, the flare portion of the tubing end and the flare nut. Where the swivel fitting assembly is not pre-assembled, the sealing member and retaining ring are preferably installed into the threaded end cap in the appropriate positions. The threaded end cap is then axially displaced onto the base fitting until the retaining ring engages the groove in the base fitting and retains the threaded end cap thereon. At which point, the sealing member will preferably be compressively positioned between the base fitting and the threaded end cap.

It will be appreciated that the foregoing discussion of a method of assembling a fluid line connector is equally applicable to other embodiments of fluid line connectors in accordance with the present invention including, but not limited to, connector assembly 200. It will be further appreciated that, in certain configurations, some of the foregoing steps can be modified or omitted or other steps added without departing from the principles of the present invention. One such alternate method of assembly of a fluid line connector assembly 200 is substantially identical to that discussed above with regard to connector assembly 100, except that a braided sheath 290 that extends about the exterior of the tubing and along its length is provided and installed prior to the installation of the flare nuts, as discussed above. In such case, the braided sheath is preferably secured to the tubing at each tubing end by a suitable method, such as by crimping or otherwise radially inwardly deforming a braid retaining collar 296 about a portion of the braided sheath, for example. Thereafter, the provided flare nuts are installed and assembly proceeds as discussed above.

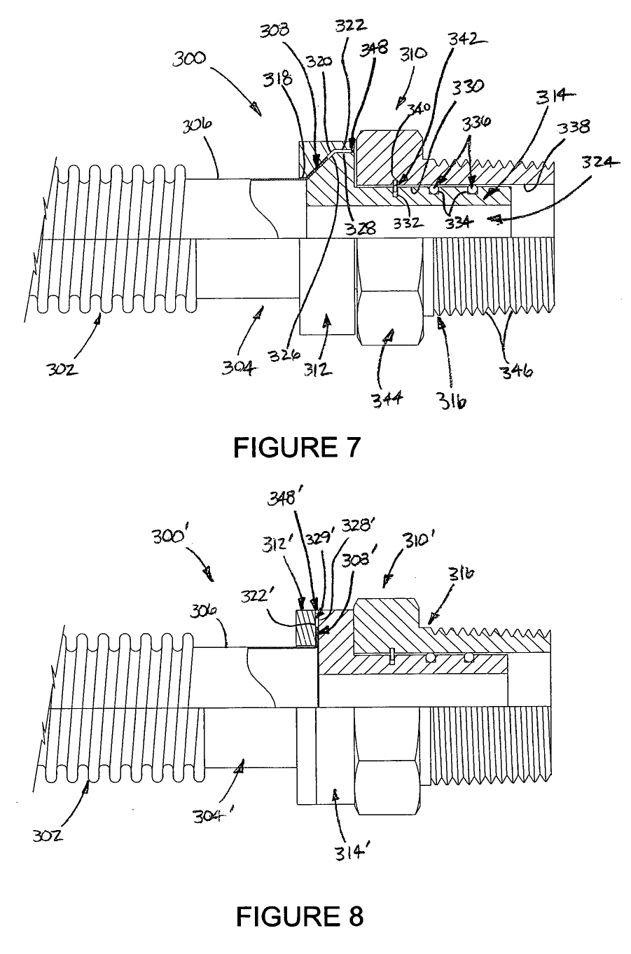

Additionally, other end fitting assemblies can be used to construct fluid line connector assemblies in accordance with the present invention. Such connector assemblies can optionally include a braided sheath and/or a coating layer as discussed in detail hereinbefore, though such features are not shown in and/or described with regard to FIGS. 7-16. It will be appreciated that the various end fitting configurations shown in and described with regard to FIGS. 7-16 provide a fluid-tight end fitting on a length of flexible tubing and that the end fitting includes a rotatable or swivel portion supported thereon.

FIG. 7 illustrates a fluid line connector assembly 300 that includes a length of thin-walled flexible tubing 302 having a tubing end 304. The tubing end includes a generally cylindrical journal portion 306 and a radially outwardly extending flared portion 308 positioned along tubing end 304 outward of journal portion 306. An end fitting assembly 310 is supported on tubing end 304 and includes an outer flare ring 312, an inner flare fitting 314, and a swivel fitting 316 that is rotatably supported on inner flare fitting 314. Outer flare ring 312 includes a generally cylindrical journal passage 318 extending therethrough and is received on journal portion 306 of tubing end 304. Frustoconical wall portion 320 extends radially outwardly from journal passage 318 to a generally cylindrical wall portion 322.

Inner flare fitting 314 includes a fluid passage 324 extending therethrough in fluid communication with flexible tubing 302. A frustoconical wall portion 326 is provided along the exterior of inner flare fitting 314 and extends radially outwardly to a generally cylindrical wall portion 328. It will be appreciated that frustoconical wall portions 320 and 326, respectively of outer flare ring 312 and inner flare fitting 314, extend radially outwardly at angles complementary with one another and suitable for forming a fluid-tight seal with flared portion 308 of tubing end 304. Frustoconical wall portions 320 and 326 are shown in FIG. 7 as having substantially identical included angles (not numbered). However, it will be appreciated that other suitable angles can be used and that the two wall portions can have different included angles without departing from the principles of the present invention. For example, the included angle (not numbered) of frustoconical wall portion 320 can be about one-half degree to about six degrees smaller than an included angle (not numbered) of frustoconical wall portion 326 such that when inner flare fitting 314 is displaced toward outer flare ring 312, the two frustoconical wall portions 320 and 326 form a metal-to-metal seal with flared portion 308 of tubing end 304.

A generally cylindrical support wall 330 extends axially from wall portion 328 and is shown in FIG. 7 as having an outside diameter that is less than the outside diameter of wall portion 328. A radially inwardly extending retaining ring groove 332 is provided along support wall 330. Two sealing member grooves 334 are also provided therealong and extend radially inwardly from support wall 330. Sealing member grooves 334 are dimensioned to receive and axially retain any suitable sealing member, such as an o-ring 336.

Swivel fitting 316 includes an inner wall 338 suitable dimensioned for being rotatably received on support wall 330 of inner flare fitting 314. Sealing members, such as o-rings 336, form a fluid-tight seal between inner wall 338 of swivel fitting 316 and grooves 334 in support wall 330. A radially outwardly extending retaining ring groove 340 is provided along inner wall 338 and axially aligned radially opposite groove 332 in support wall 330 for receiving a suitable retaining ring 342, which engages at least a portion of each of grooves 332 and 340 to axially retain swivel fitting 316 on inner flare fitting 314. Wrench flats 344 are provided along the exterior of swivel fitting 316 and are suitable for rotating the same such that male threads 346 can be suitably engaged with a mating part (not shown), such as a female connector. It will be appreciated, however, that other configurations of the swivel fitting may alternatively or additionally include female threads of any suitable type or form.

FIG. 8 illustrates a fluid line connector assembly 300′ that is substantially similar to connector assembly 300 shown and described with regard to FIG. 7. As such, like features will be shown and described with like item numbers, and new or modified features or elements will be primed (′). Any features or elements shown and described in one figure, but having no counterpart in the other figure, will be distinctly pointed out and described where appropriate.

Fluid line connector assembly 300′ includes a length of thin-walled flexible tubing 302 having a tubing end 304′ with a generally cylindrical journal portion 306 and a radially outwardly extending flange portion 308′. An end fitting assembly 310′ is supported on tubing end 304′ and includes a flange ring 312′, a flange fitting 314′ and a swivel fitting 316. In FIG. 8, flanged portion 308′ extends radially outwardly in a direction generally transverse to journal portion 306. As such, frustoconical wall portions 320 and 326 shown in FIG. 7 are not provided. Rather, flanged portion 308′ is compressively positioned between end wall 322′ of flange ring 312′ and end wall 328′ of flange fitting 314′. It will be appreciated that end wall 328′ of flange fitting 314′ is formed by an annular recess 329′ extending axially into flange fitting 314′ such that flanged portion 308′ of tubing end 304′ is received therein. It will be appreciated, however, that such an annular recess can be additionally or alternately provided in end wall 322′ of flange ring 312′.

Fluid line connector assemblies 300 and 300′, shown respectively in FIGS. 7 and 8, will be assembled in a substantially identical manner. As such, the following discussion of such assembly will refer to the features and item numbers shown in FIG. 7, but it will be appreciated that such assembly steps will be equally applicable to the assembly shown and described with regard to FIG. 8.

Initially, a length of flexible tubing 302 is provided having a tubing end 304 with a generally cylindrical journal portion 306 formed thereon. Outer flare ring 312 is fitted onto the journal portion and radially outwardly extending flare portion 308 is then formed thereon capturing flare ring 312 on tubing end 304. Inner flare fitting 314 is thereafter fitted into flared portion 308 of tubing end 304 and the two components are pressed together compressing flared portion 308 of tubing end 304 to form a fluid-tight, metal-to-metal seal between flare ring 312, flared portion 308 and flare fitting 314. While retained in the pressed-together relationship, flare ring 312 and flare fitting 314 are joined together by any suitable method, such as staking, pinning, brazing, tack welding or all-around welding, for example, forming a joint 348 (or 348′ in FIG. 8). It will be appreciated that the fluid-tight seal between the flare ring and the flare fitting is formed by the metal-to-metal contact with flared portion 308 and not by the joint between the flare ring and the flare fitting. Once flare ring 312 and flare fitting 314 have been suitably joined together, swivel fitting 316 can be assembled onto flare fitting 314 and retained thereon by retaining ring 342 with sealing members, such as o-rings 336 compressively positioned between the swivel fitting and the flare fitting to form a fluid-tight seal therebetween.

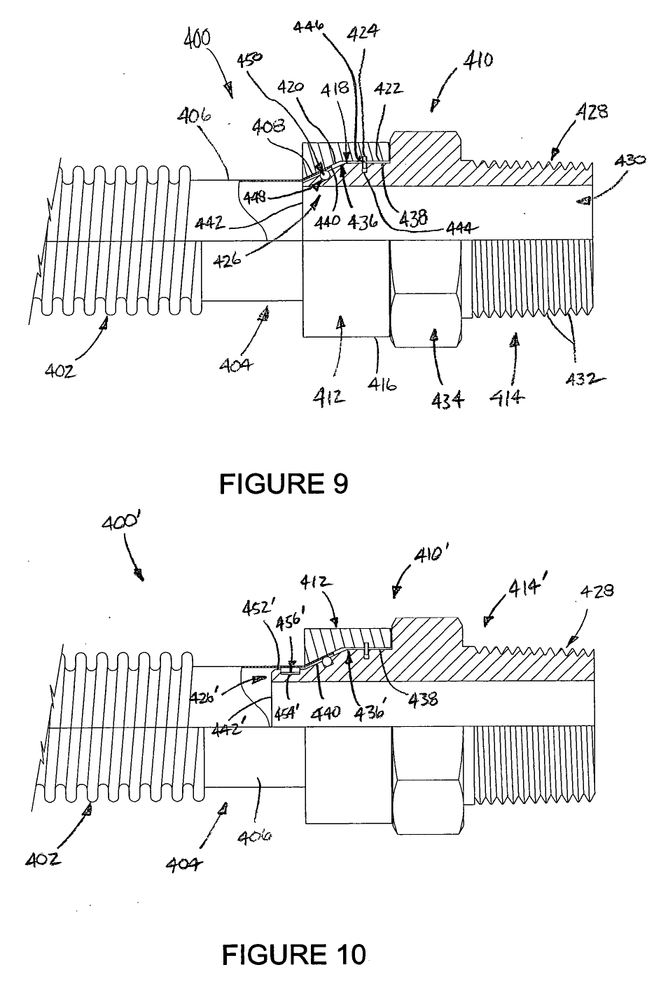

FIGS. 9-11 illustrate another embodiment of a fluid line connector assembly in accordance with the present invention. FIG. 9 illustrates a fluid line connector assembly 400 that includes a length of thin-walled flexible tubing 402 and an end fitting assembly 410 supported on a tubing end 404 of tubing 402. The tubing end has a generally cylindrical journal portion 406 and a radially outwardly extending flared portion 408. End fitting assembly 410 supported on tubing end 404 includes an outer flare ring 412 and a swivel fitting 414. Outer flare ring 412 has a generally cylindrical outer wall 416 and an inner wall 418 having a frustoconical wall portion 420 and a cylindrical wall portion 422. A radially outwardly extending retaining ring groove 424 is provided along cylindrical wall portion 422 of outer flare ring 412. It will be appreciated that flare ring 412 is retained on tubing end 404 by flared portion 408 thereof, and that frustoconical wall portion 420 is suitable for receiving flared portion 408 adjacent thereto.

Swivel fitting 414 has a flare-engaging end 426 and a threaded end 428 opposite flare-engaging end 426. A fluid passage 430 extends through swivel fitting 414 between ends 426 and 428. Threaded end 428 includes a plurality of male threads 432. However, it will be appreciated that female threads can alternately and/or additionally be provided, and that any such threads can be of any suitable type or form. Wrench flats 434 are provided on swivel fitting 414 between flare-engaging end 426 and threaded end 428. The flare-engaging end includes an outside wall 436 having a generally cylindrical wall portion 438 and a frustoconical wall portion 440 that extends from cylindrical wall portion 438 to fitting edge 442. A radially inwardly extending retaining ring groove 444 is provided in swivel fitting 414 along cylindrical wall portion 438. Retaining ring groove 444 is axially aligned radially opposite retaining ring groove 424 in flare ring 412, and a retaining ring 446 is at least partially received in each of grooves 424 and 444 to axially retain swivel fitting 414 on outer flare ring 412. Frustoconical wall portion 440 includes a seal groove 448 for receiving a sealing member, such as an o-ring 450, for example. Flared portion 408 of tubing end 404 is captured between frustoconical wall portions 420 and 440. O-ring 450 is compressively positioned between flared portion 408 of tubing end 404 and seal groove 448 of swivel fitting 414 forming a fluid-tight seal along the tubing end while remaining rotatable relative thereto.

Fluid line connector assembly 400′ is substantially similar to connector assembly 400 shown in and discussed with regard to FIG. 9. As such, like features will be identified by and discussed using like item numbers, and new or modified features or elements will be identified by and discussed using primed (′) item numbers.

Fluid line connector assembly 400′ includes a length of thin-walled flexible tubing 402 and an end fitting assembly 410′ supported on tubing end 404, as discussed with regard to FIG. 9. End fitting assembly 410′ includes an outer flare ring 412 and a swivel fitting 414′ that has a flare-engaging end 426′ and a threaded end 428. An outside wall 436′ extends along flare-engaging end 426′ and includes a generally cylindrical wall portion 438, a frustoconical wall portion 440, and an extension wall portion 452′ extending between frustoconical wall portion 440 and a fitting edge 442′. Extension wall portion 452′ is dimensioned to fit into journal portion 406 of tubing end 404. The extension wall portion includes a seal groove 454′ suitable for receiving a sealing member, such as a gasket 456′, for example, and capturing the sealing member between journal portion 406 of tubing end 404 and the seal groove. As such, swivel fitting 414′ remains freely rotatable relative to tubing end 404, while forming a fluid-tight seal therewith.

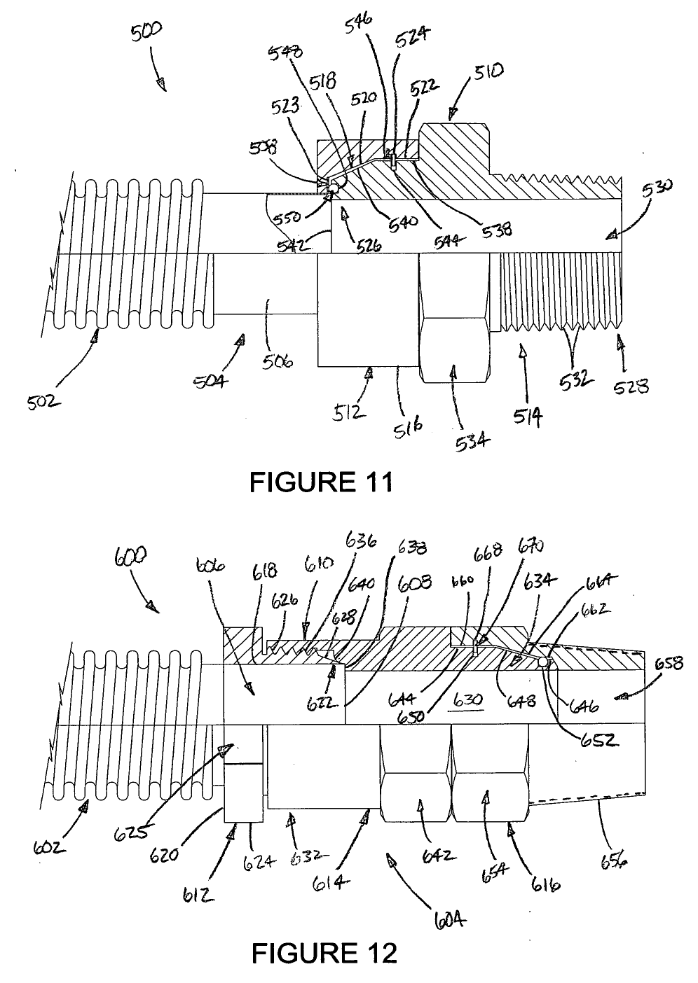

FIG. 11 illustrates a fluid line connector assembly 500 that is substantially similar to that is shown in and described with regard to FIG. 9. Unless otherwise indicated, the features in FIG. 11 correspond to those illustrated in and discussed with respect to FIG. 9. However, the features in FIG. 11 include reference numerals incremented by 100. Features shown and described in one drawing figure, but having no counterpart in the other figure, will be distinctly pointed out and discussed where appropriate.

Fluid line connector assembly 500 includes a length of thin-walled flexible tubing 502 and an end fitting assembly 510 supported on a tubing end 504. The tubing end has a generally cylindrical journal portion 506 and a radially outwardly extending flange portion 508 formed axially outwardly from journal portion 506 on tubing end 504. End fitting assembly 510 includes an outer flange ring 512 and a swivel fitting 514. Flange ring 512 is retained on tubing end 504 by flange portion 508. Flange ring 512 includes an outer wall 516 and in inner wall 518 that has a frustoconical wall portion 520 and a generally cylindrical wall portion 522. An end wall 523 is provided adjacent frustoconical wall portion 520 opposite and extending generally transverse to cylindrical wall portion 522. The outside diameter of flange portion 508 of tubing end 504 is preferably dimensioned to be received on and engage end wall 523. Swivel fitting 514 includes a flange-engaging end 526 and a threaded end 528 opposite the flange-engaging end. The flange-engaging end has an outside wall 536 that includes a generally cylindrical wall portion 538 and a frustoconical wall portion 540 that extends radially inwardly from wall portion 538 to a fitting edge 542. Retaining ring grooves 524 and 544 extend respectively outwardly and inwardly into flare ring 512 and swivel fitting 514. At least a portion of a retaining ring 546 is at least partially received in each of grooves 524 and 544 to retain flare ring 512 and swivel fitting 514 in axial relation to one another. A seal groove 548 is provided along fitting edge 542 and is suitable for receiving a sealing member, such as an o-ring 550, for example. It will be appreciated that flange portion 508 is captured between end wall 523 and fitting edge 542 and that o-ring 550 is compressively positioned between flange portion 508 and seal groove 548 to form a fluid-tight seal therewith. As such, swivel fitting 514 forms a fluid-tight connection with tubing 502 while remaining rotatable relative thereto.

Still another embodiment of a fluid line connector assembly in accordance with the present invention is shown in FIGS. 12-14. Fluid line connector assembly 600 shown in FIG. 12 includes a length of thin-walled flexible tubing 602 and an end fitting assembly 604 supported on a generally cylindrical tubing end 606 adjacent tubing edge 608 of tubing 602.

End fitting assembly 604 includes a connector fitting arrangement 610 having a first connector component 612 and a second connector component 614. The end fitting assembly also includes a swivel fitting 616 rotatably supported on connector component 614 of fitting arrangement 610. First connector component 612 has an inside bore 618 that extends between first component ends 620 and 622. Inside bore 618 fits onto tubing end 606 such that limited clearance is provided therebetween. The exterior of first connector component 612 includes a cylindrical portion 624 adjacent component end 620 and a plurality of male threads 626 adjacent the cylindrical portion extending toward component end 622. Wrench flats 625 are provided along cylindrical portion 624. A frustoconical wall portion 628 extends from adjacent male threads 626 along component end 622.

Second connector component 614 has a fluid passage 630 extending therealong between component ends 632 and 634. A plurality of female threads 636 extends into connector component 614 from component end 632 along fluid passage 630. A shoulder 638 is provided within fluid passage 630 inwardly adjacent threads 636. Shoulder 638 extends generally transverse fluid passage 630 and is suitably dimensioned to receive tubing end 606 of tubing 602. A compression wall 640 extends between female threads 636 and shoulder 638. Preferably, compression wall 640 is suitably adapted to engage frustoconical wall portion 628 of connector component 612 and radially inwardly displace the same as components 612 and 614 threadably engage one another by way of threads 626 and 636, respectively. In addition to forming a radially inwardly acting compression fit between end 622 of connector component 612 and tubing end 606, connector components 612 and 614 preferably threadably engage one another such that frustoconical wall portion 628 sufficiently contacts compression wall 640 to form a fluid-tight, metal-to-metal seal therebetween.

Wrench flats 642 are provided along the exterior of connector component 614. Adjacent the wrench flats along the exterior of connector component 614 are cylindrical wall portions 644 and 646 and a frustoconical wall portion 648 extending therebetween. A radially inwardly extending retaining ring groove 650 is provided on cylindrical wall portion 644, and a radially inwardly extending sealing groove 652 is provided on cylindrical wall portion 646 adjacent frustoconical wall portion 648.

Swivel fitting 616 has wrench flats 654 extending along the exterior thereof. Additionally, a plurality of male threads 656 are provided along the exterior of swivel fitting 616 adjacent wrench flats 654. A fluid passage 658 extends through swivel fitting 616. Cylindrical inside wall portions 660 and 662 extend along fluid passage 658, and a frustoconical inside wall portion 664 extends therebetween. Wall portions 660, 662 and 664 of swivel fitting 616 are complementary to wall portions 644, 646 and 648 such that swivel fitting 616 is rotatably supported on connector component 614. A radially outwardly extending retaining ring groove 668 is provided on wall portion 660, and at least a portion of retaining ring 670 is received in each of retaining ring grooves 650 and 668 to axially retain swivel fitting 616 on connector component 614.

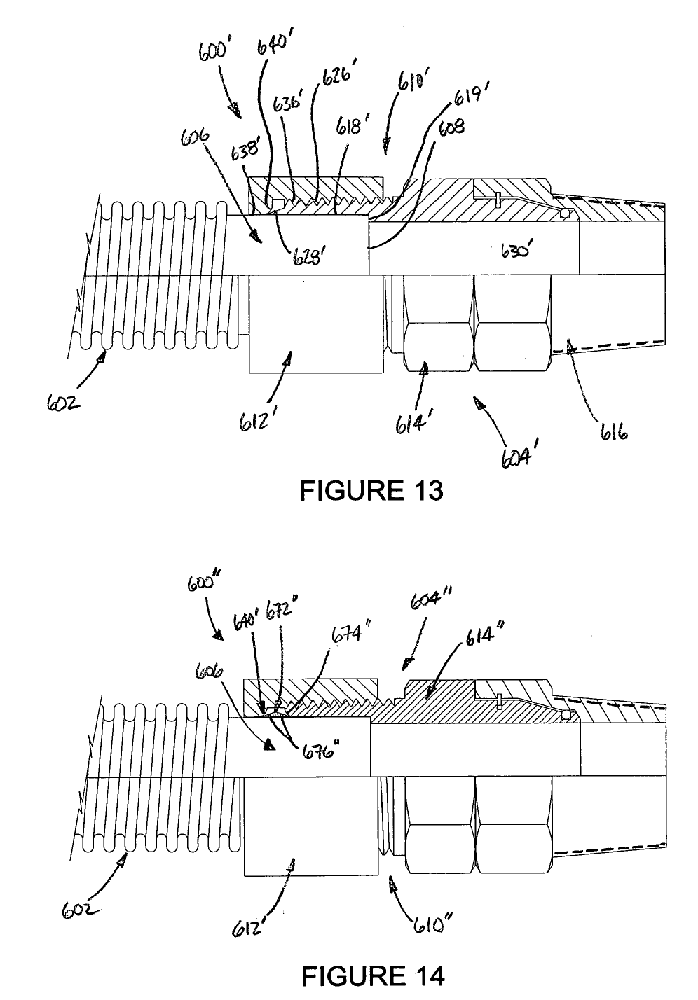

Fluid line connector assembly 600′ shown in FIG. 13 is substantially identical to connector assembly 600 shown in and discussed with regard to FIG. 12. As such, like elements and features will be identified by and discussed using like item numbers, and new or modified features and elements will be shown by and discussed using primed (′) item numbers. Features shown in and discussed with regard to one drawing, but having no counterpart in the other, will be distinctly pointed out and discussed where appropriate.

Fluid line connector assembly 600′ includes a length of thin-walled flexible tubing 602 and an end fitting assembly 604′. The end fitting assembly includes a connector fitting arrangement 610′ and a swivel fitting 616. Connector fitting arrangement 610′ includes a first connector component 612′ and a second connector component 614′. Connector component 612′ includes a plurality of female threads 636′ and inside bore 638′ with a compression wall 640′ extending therebetween. Component 612′ is positioned on tubing end 606 such that female threads 636′ extend outwardly from tubing end 606. Connector component 614′ includes an inside bore 618′ extending along a fluid passage 630′. A plurality of male threads 626′ extends along the exterior of connector component 614′ to a frustoconical wall portion 628′. Inside bore 618 slips over tubing end 606 of tubing 602, and a shoulder 619′ abuts tubing edge 608 of tubing end 606. Accordingly, as connector components 612′ and 614′ threadably engage one another, compression wall 640′ of connector component 612′ radially inwardly displaces frustoconical wall portion 628′ compressively engaging tubing end 606 and retaining end fitting assembly 604′ thereon. The resulting compressive fit between frustoconical end 628′ and tubing end 606 form a fluid-tight seal therebetween. Furthermore, frustoconical end 628′ and compression wall 640′ sufficiently contact one another to form a metal-to-metal seal therebetween. Swivel fitting 616 is rotatably supported on component 614′ as discussed hereinbefore with regard to component 614.

FIG. 14 illustrates a fluid line connector assembly 600″ that is substantially similar to fluid line connector assembly 600′ shown in and described with regard to FIG. 13. As such, like features will be identified by and described using like item numbers, and new or modified features and elements will be shown by and described using double primed (″) item numbers. Features shown in and described with regard to one drawing figure, but having no counterpart in the other drawing figure, will be distinctly pointed out and discussed where appropriate.

Fluid line connector assembly 600″ includes an end fitting assembly 604″ supported on a generally cylindrical tubing end 606 of a length of thin-walled flexible tubing 602. End fitting assembly 604″ includes a connector fitting arrangement 610″ and a swivel fitting 616. Connector fitting arrangement 610″ includes first connector component 612′ and second connector component 614″ as well as a compression ring 672″. It will be appreciated that connector component 614″ does not include a feature similar to frustoconical wall portion 628′ shown in FIG. 13. Rather, in place of such a feature, connector component 614″ includes a compression wall 674″ that is substantially similar to compression wall 640′ on connector component 612′. Compression ring 672″ includes two oppositely extending frustoconical external wall portions 676″, and a generally cylindrical inside wall having an inside diameter dimensioned such that the compression ring slips onto tubing end 606. As connector components 612′ and 614″ are threadably engaged toward one another, the respective compression walls thereof engage frustoconical external wall portions 676″ of compression ring 672″ and radially inwardly displace the same forming a compressive seal between the compression ring and tubing end 606. As such, end fitting assembly 604″ is retained on tubing 602 thereby. It will be appreciated that compression ring 672″ can be formed from any suitable material including both metals and polymer materials, for example.

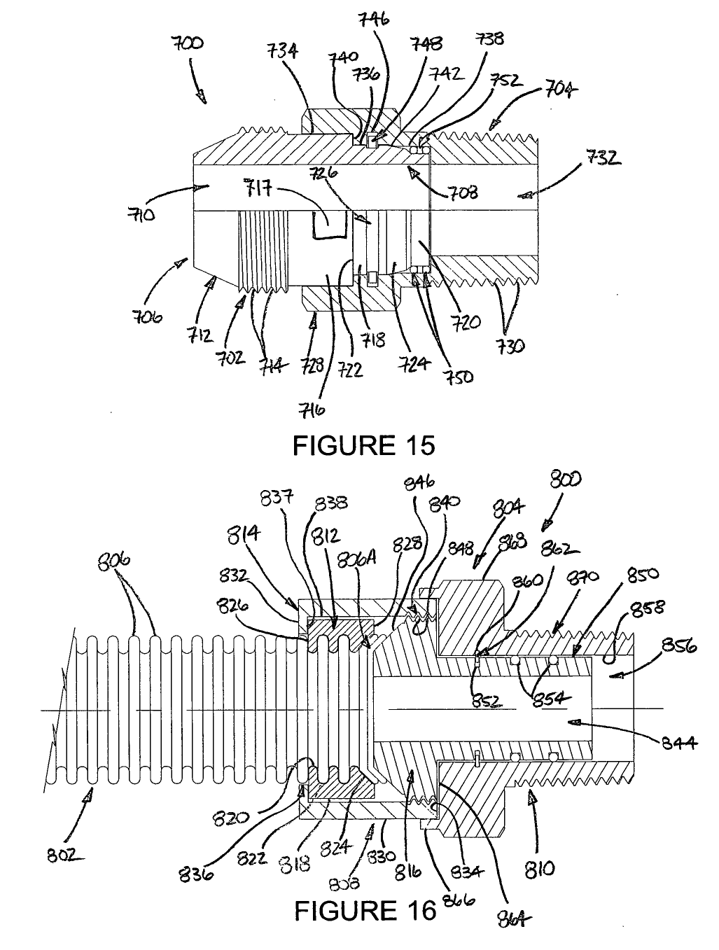

FIG. 15 illustrates an end fitting assembly 700 for use in association with a suitable fluid line connector, such as connector assembly 100 shown in FIGS. 3 and 4. In such an arrangement, end fitting assembly 700 is preferably used in place of swivel fitting assembly 140. End fitting assembly 700 includes a connector fitting 702 and a swivel fitting 704 rotatably supported on connector fitting 702. The connector fitting has a connection end 706 and a swivel end 708. A fluid passage 710 extends through connector fitting 702 between ends 706 and 708. The exterior of connector fitting 702 includes a frustoconical wall portion 712 and a plurality of male threads 714 adjacent wall portion 712. Cylindrical wall portions 716, 718 and 720 extend along the exterior of connector fitting 702 adjacent swivel end 708. A shoulder 722 extends between wall portions 716 and 718, and one or more frustoconical wall portions extend between cylindrical wall portions 718 and 720. Cylindrical wall portion 718 includes a radially inwardly extending retaining ring groove 726. A plurality of wrench flats 717 can optionally be provided on cylindrical wall portion 716.

Extending along the exterior of swivel fitting 704 are wrench flats 728 and a plurality of male threads 730. A fluid passage 732 extends through swivel fitting 704 and is suitably dimensioned to cooperate with fluid passage 710 extending through connector fitting 702. Inside cylindrical wall portions 734, 736 and 738 extend along fluid passage 732. A shoulder 740 suitable for cooperating with shoulder 722 of connector fitting 702 extends between cylindrical wall portions 734 and 736 of swivel fitting 704. A frustoconical wall portion 742 extends between cylindrical wall portions 736 and 738. Cylindrical wall portion 738 extends from frustoconical wall portion 742 to an end wall 744 extending generally transverse fluid passage 732. Cylindrical wall portion 736 includes a radially outwardly extending retaining ring groove 746 that is axially aligned radially opposite retaining ring groove 726 of connector fitting 702. A retaining ring 748 is at least partially received within each of grooves 726 and 746 to axially retain swivel fitting 704 on connector fitting 702. One or more sealing members, such as o-rings 750, are compressively positioned between cylindrical wall portion 720 of connector fitting 702 and cylindrical wall portion 738 of swivel fitting 704. The o-rings are axially retained by end wall 744 of swivel fitting 704 and by frustoconical wall portion 724 of connector fitting 702. A spacer ring 752 can be included where two or more sealing members, such as o-rings 750, are used.

Installation and/or assembly of end fitting assembly 700 includes threadably engaging connector fitting 702 into a suitable mating flare nut, such as flare nut 120 of connector assembly 100, for example, such that frustoconical wall portion 712 engages a flare portion, such as flare portion 116, for example, of an associated tubing end, such as tubing end 112, for example. As connector fitting 702 and the associated flare nut are threadably advanced toward one another, frustoconical wall portion 712 engages the flare portion of the tubing end and forms a metal-to-metal seal therewith. It will be appreciated that wrench flats 717 or other suitable features provided along cylindrical wall portion 716 of connector fitting 702 can be used to tighten connector fitting 702 and the associated flare nut together to ensure the metal-to-metal seal with the flared portion of the tubing end. As swivel fitting 704 is thereafter installed on connector fitting 702, cylindrical wall portion 734 preferably advances the over the wrench flats of connector fitting 702 and cover the same such that the wrench flats are unavailable for further engagement.

Still a further fluid line connector assembly 800 in accordance with the present invention is shown in FIG. 16. The connector assembly includes a length of thin-walled flexible tubing 802 and an end fitting assembly 804. Tubing 802 includes a plurality of corrugations 806 extending therealong. It will be appreciated that corrugations 806 can be of any suitable form and configuration, such as helical or annular corrugations, for example. End fitting assembly 804 includes a connector fitting arrangement 808 and a swivel fitting 810 rotatably supported thereon.

Connector fitting arrangement 808 includes connector ring 812, connector nut 814 and connector post 816. Connector ring 812 has a generally cylindrical outside wall 818 and an inside wall 820 having a plurality of corrugations 822 and a frustoconical wall portion 824. It will be appreciated that corrugations 822 suitably cooperate with and engage corrugations 806 of flexible tubing 802. Connector ring 812 also has end walls 826 and 828 extending generally transverse outside wall 818. It will be appreciated that connector ring 812 is a split ring allowing the same to be spread apart at the split (not shown) to extend over and engage corrugations 806 of flexible tubing 802.

Connector nut 814 has a generally cylindrical outside wall 830 extending between opposing end walls 832 and 834. An inside wall 836 extends through the connector nut and has an intermediate wall portion 837 extending radially outward to a generally cylindrical wall portion 838 that includes a plurality of female threads 840 adjacent end wall 834. It will be appreciated that cylindrical wall portion 838 is dimensioned to receive outside wall 818 of connector ring 812, and that connector nut 814 engages connector ring 812 such that walls 837 and 826 are in abutting engagement with one another. It will be further appreciated that connector nut 814 is fitted onto tubing 802 prior to the assembly of connector ring 812 onto the tubing end interengaging corregations 806.

Connector post 816 has a fluid passage 844 extending therethrough. The exterior of connector post 816 includes a frustoconical wall portion 846 provided at one end thereof, a plurality of male threads 848 adjacent the frustoconical wall portion, and a generally cylindrical wall portion 850. Threads 848 of connector post 816 threadably engage threads 840 of connector nut 814. As the connector nut and connector post are threaded together, frustoconical wall portion 846 is advanced toward frustoconical wall portion 824 of connector ring 812 forming compressed corrugations 806A therebetween, which forms a fluid-tight seal between corrugations 806A and frustoconical wall portion 846 of the connector post. Cylindrical wall portion 850 of connector post 816 includes a radially inwardly extending retaining ring groove 852 and one or more radially inwardly extending sealing grooves 854.

Swivel fitting 810 is rotatably supported on connector post 816 of fitting arrangement 808. The swivel fitting has a fluid passage 856 extending therethrough formed by an inside wall 858. A radially outwardly extending retaining ring groove 860 extends into swivel fitting 810 from inside wall 858 and is positioned therealong adjacent retaining ring groove 852 on connector post 816. A retaining ring 862 is at least partially received in each of retaining ring grooves 852 and 860 to axially retain swivel fitting 810 on connector post 816 of fitting arrangement 808. A counter bore extends axially into swivel fitting 810 from adjacent connector nut 814 forming a shoulder 864 and an axially extending annular ring 866 that is suitably dimensioned to extend over outside wall 830 of the connector nut. Wrench flats 868 are provided along the exterior of swivel fitting 810 and a plurality of male threads 870 are provided adjacent the wrench flats.

While the invention has been described with reference to the preferred embodiments and considerable emphasis has been placed herein on the structures and structural interrelationships between the component parts of the embodiments disclosed, it will be appreciated that other embodiments of the invention can be made and that many changes can be made in the embodiments illustrated and described without departing from the principles of the invention. Obviously, modifications and alterations will occur to others upon reading and understanding the preceding detailed description. For example, the flared portion of the tubing ends are shown as being flared at an included angle of about 60 degrees in certain embodiment, such as those shown in FIGS. 9 and 10, for example; or at an included angle of about 90 degrees in other embodiments, such as those shown in FIGS. 3-7, for example; or at an included angle of about 180 degrees in other embodiments, such as those shown in FIG. 8, for example. As such, an included angle of from about none or 0 degrees (in the case of a non-flared end) to an angle of about 180 degrees or more can be used. Accordingly, it is to be distinctly understood that the foregoing descriptive matter is to be interpreted merely as illustrative of the present invention and not as a limitation. As such, it is intended that the invention be construed as including all such modifications and alterations insofar as they come within the scope of this disclosure.

1. A fluid line connector assembly comprising:
a length of flexible tubing having a tubing end;
a first fitting body received on said tubing end;
a second fitting body secured to said first fitting body, at least one of said first fitting body and said second fitting body forming a fluid-tight connection with said tubing end;
a third fitting body rotatably supported on said second fitting body; and,
a sealing member forming a fluid-tight seal between said second fitting body and said third fitting body.

2. A fluid line connector assembly according to claim 1, wherein said second fitting body includes an inwardly extending groove.

3. A fluid line connector assembly according to claim 2, wherein said third fitting body includes an outwardly extending groove in substantial alignment with said inwardly extending groove of said second fitting body.

4. A fluid line connector assembly according to claim 3 further comprising a retaining member at least partially received within a portion of each of said inwardly extending groove and said outwardly extending groove.

5. A fluid line connector assembly according to claim 1, wherein said sealing member is compressively positioned between said second fitting body and said third fitting body.

6. A fluid line connector assembly according to claim 5, wherein said sealing member is an o-ring.

7. A fluid line connector assembly according to claim 1, wherein said tubing end includes an outwardly extending flared portion, and said flared portion is positioned between said first fitting body and said second fitting body.

8. A fluid line connector assembly according to claim 7, wherein said first fitting body has an inside wall that includes a plurality of threads, and said second fitting body has an outside wall that includes a plurality of corresponding threads, said second fitting body is secured to said first fitting body by interengaging said threads.

9. A fluid line connector assembly according to claim 7, wherein said second fitting body is secured to said first fitting body by a welded joint.

10. A fluid line connector assembly according to claim 7, wherein at least one of said first fitting body and said second fitting body includes a flare-engaging surface in abutting engagement with said flared portion of said tubing end.

11. A fluid line connector assembly according to claim 10, wherein each of said first fitting body and said second fitting body includes a flare-engaging surface, and said flared portion of said tubing end is compressively positioned between said flare engaging surfaces.

12. A fluid line connector assembly according to claim 1 further comprising a sheath extending along at least a portion the exterior of said length of tubing.

13. A fluid line connector assembly according to claim 12 further comprising a polymeric coating extending along at least a portion of said sheath.

14. A fluid line connector assembly according to claim 1, wherein said length of flexible tubing includes a plurality of corrugations.

15. A fluid line connector assembly according to claim 14, wherein said first fitting body includes an annular rib engaging one of said plurality of corrugations.

16. A fluid line connector assembly according to claim 15 further comprising a fourth fitting body extending between said first fitting body and said second fitting body.

17. A fluid line connector assembly according to claim 16, wherein said fourth fitting body includes a radially inwardly extending flange portion engaging a wall of said first fitting body and a threaded portion engaging a corresponding threaded portion of said second fitting body.

18. A fluid line connector assembly comprising:
a length of flexible tubing having a tubing end;
a first fitting body received on said tubing end;
a second fitting body rotatably supported on said first fitting body; and,
a sealing member forming a fluid-tight seal between said tubing end and one of said first fitting body and said second fitting body.

19. A fluid line connector assembly according to claim 18, wherein said second fitting body includes an inwardly extending groove.

20. A fluid line connector assembly according to claim 19, wherein said sealing member is an o-ring at least partially received in said groove.

21. A fluid line connector assembly according to claim 19, wherein said first fitting body includes an outwardly extending groove in substantial alignment with said inwardly extending groove on said second fitting body.

22. A fluid line connector assembly according to claim 21 further comprising a retaining member at least partially received within a portion of each of said grooves.

23. A fluid line connector assembly comprising:
a length of flexible tubing having a tubing end;
a first fitting body received on said tubing end;
a second fitting body secured to said first fitting body, at least one of said first fitting body and said second fitting body at least partially forming a compression seal along said tubing end;
a third fitting body rotatably supported on said second fitting body; and,
a sealing member forming a fluid-tight seal between said second fitting body and said third fitting body.

24. A fluid line connector assembly according to claim 23, wherein one of said first and second fitting bodies includes a substantially frustoconical wall, and the other of said first and second fitting bodies includes a compression wall in abutting engagement with said substantially frustoconical wall.

25. A fluid line connector assembly according to claim 23, wherein said second fitting body includes an inwardly extending groove.

26. A fluid line connector assembly according to claim 25, wherein said sealing member is an o-ring at least partially received in said groove.

27. A fluid line connector assembly according to claim 25, wherein said first fitting body includes an outwardly extending groove in substantial alignment with said inwardly extending groove on said second fitting body.

28. A fluid line connector assembly according to claim 27 further comprising a retaining member at least partially received within a portion of each of said grooves.

29. A fluid line connector assembly comprising:
a length of flexible tubing having a tubing end;
a first fitting body received on said tubing end;
a second fitting body secured to said first fitting body;
a compression ring captured on said tubing end between said first and second fitting bodies, said compression ring at least partially forming a compression seal along said tubing end;
a third fitting body rotatably supported on said second fitting body; and,
a sealing member forming a fluid-tight seal between said second fitting body and said third fitting body.

30. A fluid line connector assembly according to claim 29, wherein said compression ring includes a substantially frustoconical wall and at least one of said first and second fitting bodies includes a compression wall in abutting engagement with said substantially frustoconical wall.

31. A fluid line connector assembly according to claim 30, wherein said compression ring includes two opposing, substantially frustoconical walls and each of said first and second fitting bodies includes a compression wall in abutting engagement with a different one of said substantially frustoconical wall.

32. A method of assembling a fluid line connector assembly comprising steps of:
a) providing a length of flexible tubing having a tubing end, a first fitting body, a second fitting body having an inwardly extending groove, a third fitting body having an outwardly extending groove, a sealing member and a retaining member;
b) positioning said first fitting body on said tubing end;
c) securing said second fitting body on said first fitting body and forming a fluid-tight seal between one of said first and second fitting bodies and said tubing end;
d) positioning said sealing member on said second fitting body and said retaining member within at least a portion of said inwardly extending groove; and,
e) positioning said third fitting body on said second fitting body such that said retaining member is received within at least a portion of said outwardly extending groove and said sealing member is compressively positioned between said second and third fitting bodies.

33. A method according to claim 32, wherein each of said first and second fitting bodies include a corresponding first and second plurality of threads, and step c) includes interengaging said threads to secure said second fitting body on said first fitting body.
